(19) United States
(12) Patent Application Publication
(10) Pub. No.: US 2010/0198813 A1
(43) Pub. Date: Aug. 5, 2010

(54) SYSTEMS AND METHODS FOR A SEARCH ENGINE RESULTS PAGE RESEARCH ASSISTANT

(76) Inventors: Liang Yu Chi, San Francisco, CA (US); Chi Chung Marcus Chan, San Francisco, CA (US); Hong Zhu, San Jose, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 12/365,881

(22) Filed: Feb. 4, 2009

(51) Int. Cl. G06F 17/30

(52) U.S. Cl. 707/722; 707/E17.014

(57) ABSTRACT

The present invention is directed towards systems and methods for performing search engine research. The method according to one embodiment of the present invention comprises receiving a search query from a user and determining if a user is performing research. The method then generates a research set associated with the research and stores at least one query with the research. The method then provides a search engine results page in response to the query, monitors the search engine results page for user interactions and stores at least one user interact with said search engine results page.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

Embodiments of the invention described herein generally relate to enhancing the use of a search engine as a research tool. More specifically, embodiments of the present invention are directed towards systems, methods and computer program products for analyzing research activity of a user, thereby allowing the user to record and manipulate his or her past research.

### BACKGROUND OF THE INVENTION

As the volume of information available on the Internet rapidly expands, the efficiency of using search engines to conduct research has become a primary concern for both search engine providers and search engine users. Presently, the ability to retrieve relevant results and provide those results in an efficient and intuitive manner often determines whether a search engine is a success or a failure and great strides have been made to increase the relevancy of search results for a given query. For example, sophisticated indexing techniques and behavioral analysis, through techniques such as click tracking, have been implemented and refined to ensure the highest quality results are returned for a given query. Little effort has been made, however, in allowing users to organize these search queries and their associated results.

While search engines may provide highly relevant results, users are commonly forced to utilize antiquated methods to record their search patterns, history, and relevant links. For example, users are forced to manually record their search results using a text editor or even pen and paper. Additionally, modern search engines generally ignore search patterns, focusing primarily on the instant query without regard to state. That is, search engines generally do not correlate related, subsequent queries as being part of a user's search goal or research goal. While a search engine may provide highly relevant results for the queries “plasma TV” and “LCD TV” independently, the search engine ignores potential relationships between the two queries (e.g., a relationship between the two queries indicating that a user may be researching televisions he or she wishes to purchase).

This failure to appreciate state or relationships among queries results in user frustration as well as a loss of data that may be forgotten by the user. Furthermore, these issues are amplified for search patterns that span multiple days, weeks or even months. Consider, for example, a user researching information related to purchasing a new car. Few, if any, users would enter a single search query and purchase a vehicle immediately. Rather, a user may enter multiple queries over the span of weeks or months and record his or her results, as well as notes and ancillary information, for later viewing, comparison or analysis. Search engines ignore this pattern and shift the burden to the user to take affirmative steps to organize the vast amounts of potentially relevant search data. The result is that a user may erroneously transcribe search queries, omit websites he or she may find relevant, or may overwhelm themselves with an abundance of unorganized data (e.g., an overwhelming amount of bookmarks).

Thus, there exists a need in the current state of the art for systems, methods and computer program products that allow users to organize search-related research in an intuitive and organized fashion. Specifically, there exists a need to identify research sessions and provide the user with information he or she deems relevant in an organized fashion.

### SUMMARY OF THE INVENTION

The present invention is directed towards systems and methods for performing search engine research. The method of the present invention comprises receiving a search query form a user and determining if the user is performing research. In one embodiment, determining if the user is performing research comprises utilizing a multi-level decision tree wherein said multi-level decision tree a plurality of metrics including past queries, search result selections, edit distance, or timestamp difference. Additionally, determining if the user is performing research may comprise determining if an existing research set exists.

The method then generates a research set associated with the research. In one embodiment, the research is stored on a client device and may be operative to transmit the research stored on a client device to a search engine in response to a user request, wherein said user request comprises selecting a save option. The method then stores at least on query associated with the research and provides a search engine results page in response to the search query.

The system then monitors the search engine results page for user interaction. In one embodiment, monitoring the search engine results page comprises transmitting an interaction beacon in response to a user interaction, wherein said user interaction comprises selecting a search result. In a first embodiment, an interaction beacon comprises an asynchronous beacon triggered in response to the selection of a search result. In an alternative embodiment, an interaction beacon comprises a search engine redirect activated upon the selection of a search result. The method may then at store least one user interaction with said search engine results page. In one embodiment, the method may additionally display data associated with the research, said data comprising a plurality of queries and user interactions. In alternative embodiments, displaying data associated with the research comprises displaying the research data within a search results page.

The system of the present invention comprises a plurality of client devices coupled to a network. In one embodiment, the client device is further operative to display data associated with the research, said data comprising a plurality of queries and user interactions. In an alternative embodiment, displaying data associated with the research comprises displaying the research data within a search results page.

The system further comprises a search engine operative to receive search queries from said client devices via said network and return a search engine results page to said client devices and a research detector operative to determine if the user is performing research. The system may further comprise a research controller operative to generate a research set associated with the research and monitor said search engine results page for user interaction.

In a first embodiment, the research controller and research detector are located within said client device. In an alternative embodiment, the research controller and research detector are located within said search engine. The research controller may further operative to transmit an interaction beacon in response to a user interaction, wherein a user interaction comprises selecting a search result. In a first embodiment, an interaction beacon comprises an asynchronous beacon triggered in response to the selection of a search result. In an alternative embodiment, an interaction beacon comprises a search engine redirect activated upon the selection of a search result.

In alternative embodiments, the research detector may be further operative to utilize a multi-level decision tree to determine if the user is performing research wherein the multi-level decision tree a plurality of metrics including past queries, search result selections, edit distance, or timestamp difference. Research detector may further be operative to determine if an existing research set exists.

The system further comprises a storage module operative to store at least on query associated with the research and at least one user interaction with said search engine results page. In a first embodiment, the storage module is located within said client device. In a second embodiment, the storage module is located within said search engine. In alternative embodiments, the system may further comprise a lightweight storage module located on said client device, the lightweight storage module operative to transmit data to said storage module in response to a user request, wherein said user request comprises selecting a save option.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram depicting a system for providing a search engine results page research assistant according to one embodiment of the present invention;

FIG. 2 presents a block diagram depicting an alternative system for providing a search engine results page research assistant according to one embodiment of the present invention;

FIG. 3 presents a block diagram depicting a system for gathering search research data according to one embodiment of the present invention;

FIG. 4 presents a flow diagram illustrating a method for recording search research data according to one embodiment of the present invention;

FIG. 5 presents a flow diagram illustrating a method for determining whether a search query belongs to an existing research set according to one embodiment of the present invention;

FIG. 6 presents a flow diagram illustrating an alternative method for determining whether a search query belongs to an existing research set according to one embodiment of the present invention; and

FIG. 7 presents a flow diagram illustrating a method for manipulating a research set graphical user interface according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

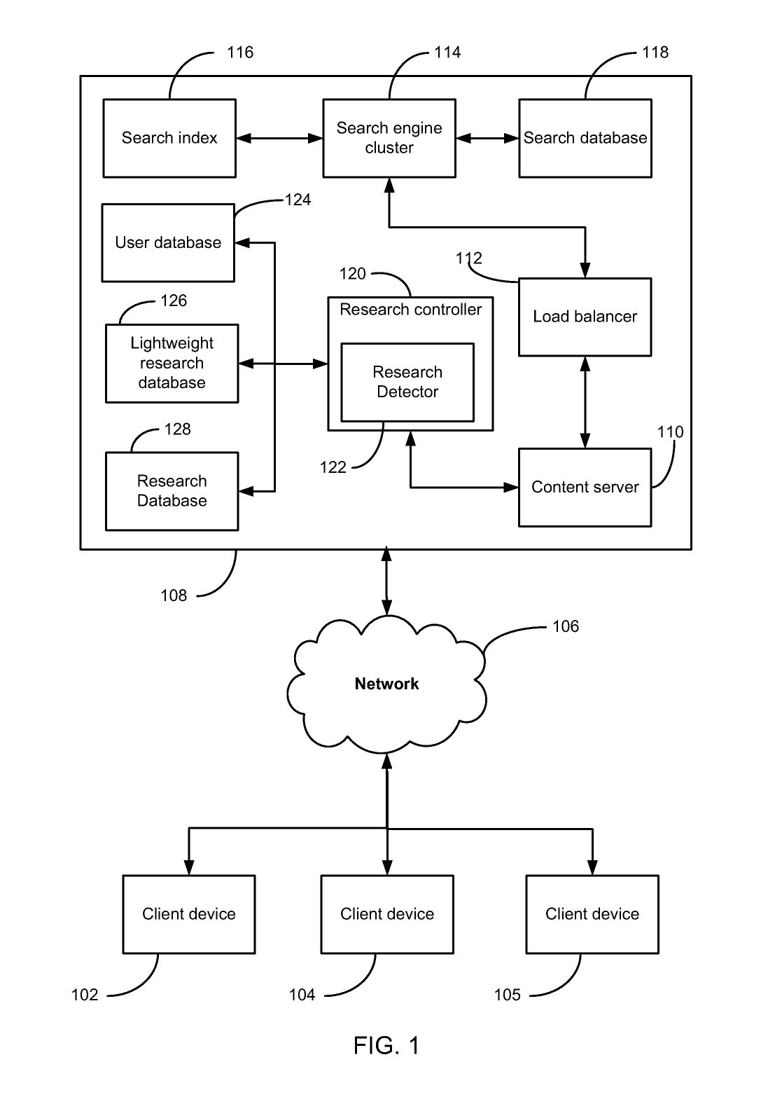

FIG. 1 presents a block diagram depicting a system for providing a search engine results page research assistant according to one embodiment of the present invention. As the embodiment of FIG. 1 illustrates, a plurality of client devices 102, 104 and 105 are connected to a content provider 108 via a network 106. According to the embodiment of FIG. 1, the content provider 108 comprises a content server 110; a load balancer 112; a search engine cluster 114; a search index 116; a search database 118; a research controller 120; a research detector 122; a user database 124; a lightweight research database 126; and a research database 128.

Client devices 102, 104 and 105 may comprise general purpose computing (mobile or otherwise) devices having a central processing unit, memory unit, permanent storage, optical drive(s), universal serial bus port(s), audio/video output devices, network interfaces, etc. Client devices 102, 104 and 105 are operative to communicate via network 106, which may comprise a local or wide area network such as the Internet. In the present embodiment, client devices 102, 104 and 105 transmit requests to content provider 108 via the HTTP, WAP or similar protocol for the client/server exchange of text, images and other data.

Content provider 108 comprises a content server 110 operative to receive incoming requests and manage outgoing transmissions of data to a given client device 102, 104 and 105. Content server 110 is communicatively coupled to load balancer 112 and research controller 120. In one embodiment, content server 110 may transmit requests for search results to load balancer 112. Accordingly, load balancer 112 may receive a plurality of serial or concurrent search requests and may distribute the requests to a search engine within search engine cluster 114. Load balancer 112 may comprise a plurality of hardware and software components known to those of skill in the art of load balancing.

Search engine cluster 114 may comprise one or more search engines, a given search engine operative to receive incoming search queries from load balancer 112. In the embodiment of FIG. 1, search engine cluster 114 (or a given search engine therein) may access search index 116 and retrieve one or more search results associated with a given query. System 100 may retrieve search results using any number of indexing techniques known to those of skill in the art including, but not limited to, use of a suffix tree, inverted index structure, n-gram index or any other search indexing technique known in the art. Search engine cluster 114 may also be communicatively coupled to search database 118. In one embodiment, search database 118 may store ancillary information that is relevant or otherwise related to search results that the search index 116 is operative to maintain. For example, search database 118 may store information regarding cached copies of the search results. In alternative embodiments, search database 118 may store additional information related to the search results.

Content server 110 may further be coupled to or in communication with research controller 120 and may be operative to transmit user interaction data or query data received from a client device 102, 104 or 105 to the research controller 120. In one embodiment, content server 110 transmits search queries comprising one or more search terms, as well as click through data indicating search results selected by a user. Research controller 120 according to one embodiment comprises a research detector 122 operative to detect when a given client device 102, 104, 105 is conducting research. In one embodiment, research detector 122 may analyze search queries and clicked search results of a user to determine if the user is performing research.

For example, research detector 122 may determine that if a user issues a plurality of successive queries and each query has repeated the same term, a user may be performing research on the repeated term. Supposing a user has submitted the queries “plasma TVs”, “LCD TVs” and “TV prices”, research detector 122 may determine a given client device 102, 104, 105 is performing research regarding televisions and may populate a research set accordingly, as is described furthermore herein.

In an alternative embodiment, the research detector 122 may analyze queries and clicked search results through use of a decision tree. In one embodiment, a decision tree may comprise a graph or model of decision relevant in determining whether a user is performing research. An exemplary decision tree is including in Appendix A

Research controller 120 is communicatively coupled to one or more databases 124, 126 and 128, in which a given database comprises a data store including, but not limited to, a flat file (e.g., CSV file), a relational database, an object-oriented database, etc. In the embodiment of FIG. 1, research controller 120 may be operative to retrieve and store user data in user database 124. For example, research controller 120 may communicate with user database 124 to authenticate a given client device 102, 104, 105 against credentials associated with one or more stored user profiles. Alternatively, or in conjunction with the foregoing, research controller 120 may access user-identifying indicia stored within the user database 124 to retrieve one or more research sets stored in either one or more of lightweight research database 126 or research database 128, which may be performed on the basis of the retrieved indicia.

Research controller 120 may be operative to maintain a connection to one or more of lightweight research database 126 and research database 128. In one embodiment, lightweight research database 126 may comprise a lightweight data store operative to store research data for immediate access by research controller 120, which may comprise retrieving research data within a given research session. As is described further herein, research data may comprise data related to a user's search goal, for example, search queries, search results and annotation related to a search goal. Research database 128 may comprise a long-term data store for inter-session storage of research data. In one embodiment, the format of research data store in databases 126 and 128 may be similar or identical. For example, databases 126 and 128 may store identical data, however database 128 may store long-term records whereas database 126 may only store short-term records. In alternative embodiments, research database 128 may store ancillary or additional information including, but not limited to, analytics data.

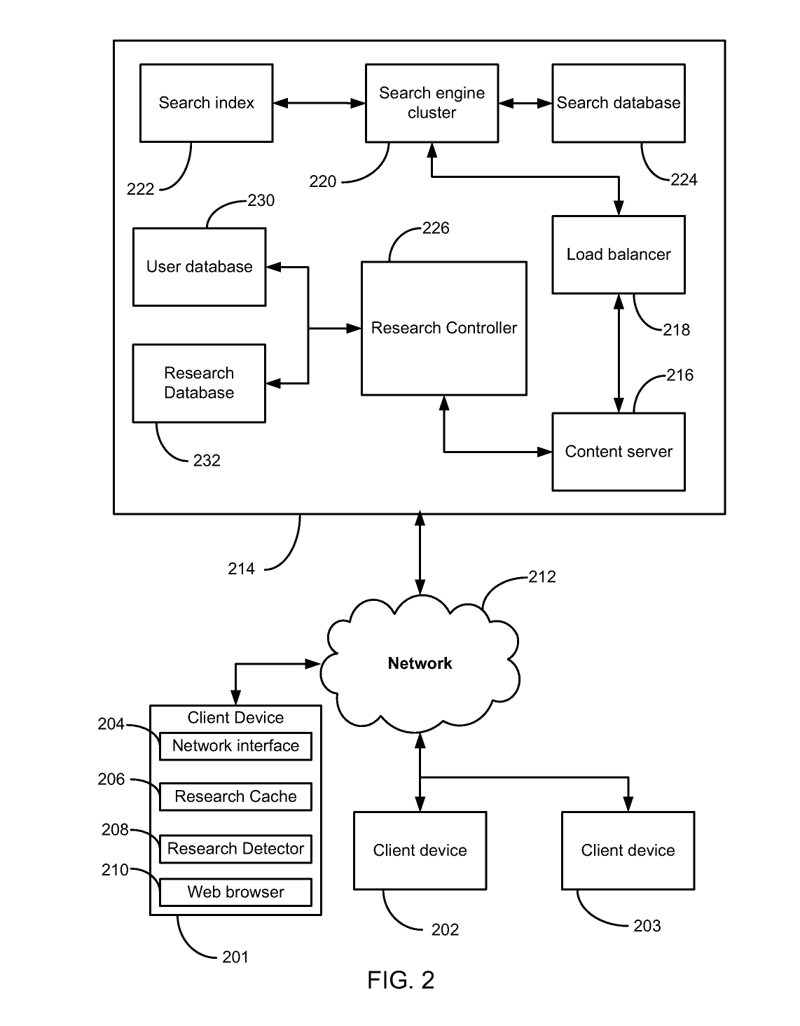

FIG. 2 presents a block diagram illustrating an alternative system for providing a search engine results page research assistant according to one embodiment of the present invention. As the embodiment of FIG. 2 illustrates, the system 200 comprises a plurality of client devices 201, 202 and 203 in communication with a content provider 214 via a network 212. In the embodiment of FIG. 2, a client device 201, 202, 203 may comprise a web browser 210, research detector 208, lightweight research cache 206 and a network interface 204. A content provider 214 may comprise a content server 216; a load balancer 218; a search engine cluster 220; a search index 222; a search database 224; a research controller 226; a research database 228; and a user database 230.

As FIG. 2 illustrates, a given client device 201, 202, 203 may comprise a web browser 210, which may be an application executing from the local memory of a client device 201, 202, 203. For example, web browser 210 may comprise any browser capable of rendering web pages transmitted by content provider 214, as well as executable code including, but not limited to, VBScript, JavaScript or the like. Client device 201, 202, 203 may further comprise a research detector 208. In one embodiment, research detector 208 may comprise computer executable program code transmitted to the client devices 201, 202, 203 from the content provider 214 for execution by a programmable processor comprising a given client device 201, 202, 203.

Research detector 208 may analyze a search queries the user submits to the content provider 214 and clicked search results rendered by the web browser 210 to determine if a user is performing research. For example, research detector 208 may determine that if a user has issued a plurality of successive queries with each query comprising a common term, a user may be performing research on the term common to the plurality of successive queries. For example, suppose a user submits the queries “plasma TVs”, “LCD TVs” and “TV prices”, research detector 208 may determine a given client device 201, 202, 203 is performing research and may generate or update a research set regarding televisions, as is discussed furthermore herein.

Client device 201, 202, 203 may further comprise a lightweight research cache 206. In the embodiment of FIG. 2, lightweight research cache 206 may comprise a lightweight data store operative to maintain one or more search results and queries, in addition to other data. For example, a lightweight data store may comprise a logical subset of an existing hard drive located on a client device 201, 202, 203. In one embodiment, a subset may comprise a cookie storage folder operative to store data for use by web pages over time. In the illustrated embodiment, lightweight research cache 206 may be operative to store a subset of a user's research data. For example, lightweight research cache 206 may store recently recorded data and may be flushed upon transmitting the recent data to a long-term storage module, such as research database 232, as is described in greater detail herein.

Client device 201, 202, 203 may transmit research data, search queries and requests for search results via network interface 204. Network interface 204 may comprise a plurality of hardware and software components operative to transmit data across a network such as a modem or Ethernet card. Client device 201, 202, 203 may transmit research data and search engine requests to content provider 214 through content server 216. Where the content server 216 determines a client device 201, 202, 203 is requesting search results (e.g., client device 201, 202, 203 is transmitting a search query), the content server 216 may transmit the search request to load balancer 218, which may be operative to receive a plurality of serial or concurrent search requests for distribution to a search engine within a search engine cluster 220. Load balancer 218 may comprise a plurality of hardware and software components known to those of skill in the art of load balancing.

Search engine cluster 220 may comprise a plurality of search engines operative to receive and process incoming search queries from load balancer 218. In the embodiment of FIG. 2, search engine cluster 220 may access search index 222 and identify one or more search results responsive to a given query. System 200 may retrieve search results using any number of indexing techniques known to those of skill in the art including, but not limited to, through the use of a suffix tree, inverted index structure, n-gram index or any other search indexing technique known in the art. Search engine cluster 220 may also be communicatively coupled to search database 224. In one embodiment, search database 224 may comprise ancillary information related to search results identified in search index 222. For example, search database 224 may comprise information regarding cached copies of the search results. Alternatively, or in conjunction with the foregoing, search database 224 may store additional information related to the search results.

Content server 216 may be coupled to research controller 226. According to one embodiment, the content server 216, upon detecting that a client device 201, 202, 203 is transferring research data, may forward the research data to research controller 226. Research controller 226 may be operative to analyze the incoming research data and may store the research data in research database 232. In one embodiment, the incoming research data may contain data identifying the client device 201, 202, 203. In response to receiving client-identifying data, research controller 226 may access user database 230 to retrieve a plurality of metrics associated with the transmitting client device 201, 202, 203. For example, research controller 226 may retrieve a plurality of research sets previously saved by a client device 201, 202, 203.

After retrieving client-identifying information, the research controller 226 may analyze the received research data. In one embodiment, the research controller 226 may analyze the research data to determine if the data should be stored in an existing research set located in research database 232. For example, the research controller 226 may retrieve a historical research set regarding the purchase of a car and may additionally determine the received research data is directed towards the same research. In this example, the research controller 226 may then store the new research data within the existing research data.

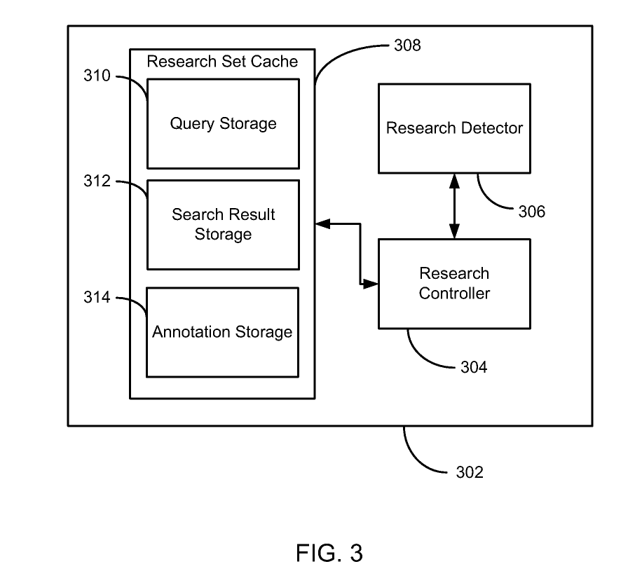

FIG. 3 presents a block diagram depicting a system for gathering research data according to one embodiment of the present invention. As the embodiment of FIG. 3 illustrates, the system 302 comprises a research controller 304 coupled to a research detector 306. Research controller is further coupled to a research set cache 308 comprising query storage 310, search results storage 312 and annotation storage 314.

In the embodiment of FIG. 3, research controller 304 may be operative to receive data from a client device (not shown). Alternatively, the system 302 may be located on a client device. In accordance with other embodiments, the system 302 may be located on a server-side device, such as a web server (not shown). In yet another embodiment, elements of system 302 may comprise a distributed computing application wherein one or more hardware and software components are located on a client device and a one or more hardware and software components are located on a server-side device.

Research controller 304 may be operative to receive research or interaction data related to a user's search activity, such as queries, clicked search results and user notes or annotations. After receiving the search research data, research controller 304 may be operative to transmit the search research data to research detector 306, which may be operative to analyze the received query to determine if a user is performing research. Research detector 306 may be operative to retrieve data from the research set cache 308. Research detector 306 may transmit the request for research set cache data through research controller 304, said requests being generated on the basis of the received search data. For example, research detector 306 may generate one or more research set cache parameters based upon the received queries. If research detector 306 determines that a received search query is directed towards computer peripherals, the research detector 306 may instruct the research controller 304 to retrieve the five most recent queries for the user to determine if he or she is researching peripherals. Alternatively, if research detector 306 determines that a received query is directed towards the purchase of a house, the research detector may instruct the research controller 304 to expand the range of search queries to six months to determine if the received query matches research stored in research set cache 308.

As previously described, the system 302 comprises a research set cache 308 comprising a plurality of storage modules 310, 312 and 314. In the embodiment of FIG. 3, storage modules 310, 312 and 314 may comprise lightweight data stores operative to store research data for fast, short-term access. In the illustrated embodiment, query storage 310 may be operative to store query data including, but not limited to, the terms present within the query, the time the query was submitted, a query identifier, query session identifying information and any other data related to search queries. Search result storage 312 may be operative to store data related to clicked search results including, but not limited to, a result URL, click time, result title, result identifier and any other data related to a search result. In one embodiment, search result storage 312 may be operative to receive click through data via a search result beacon present within a search results page. Finally, research set cache 308 may comprise annotation storage 314 operative to store annotation-related data including, but not limited to, annotation text, a search result identifier, a query identifier, an annotation time and any other data related to annotations.

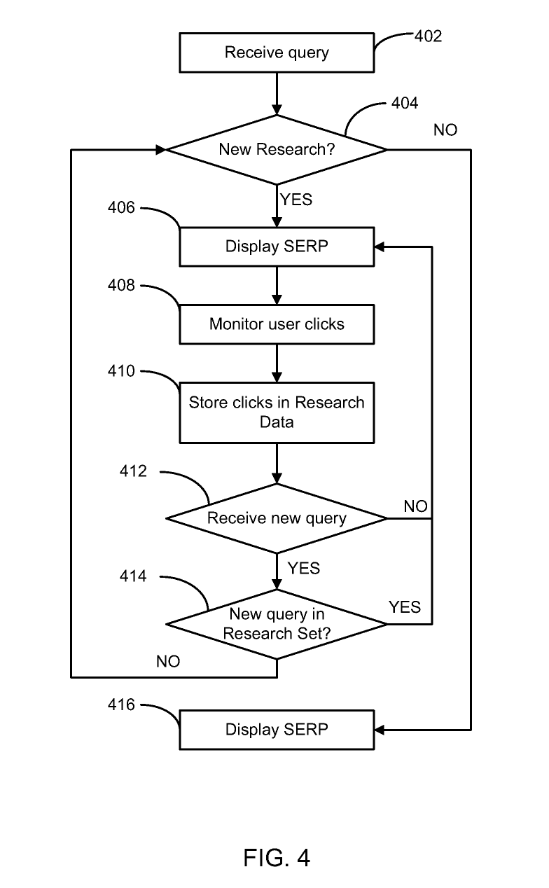

FIG. 4 presents a flow diagram illustrating a method for recording search research data according to one embodiment of the present invention. According to the embodiment of FIG. 4, the method initiates with the receipt of a query, step 402. In accordance with a first embodiment, the method comprises receiving a search query from a client device across a network such as the Internet. In an alternative embodiment, a client device may execute the method locally.

After receiving a query, a determination is made as to whether the query is part of a new or existing research set, step 404. In one embodiment, determining if a given query is part of a research set may comprise analyzing one or more past queries to determine if the given query is related to the one or more past queries. Determining if a given query is part of a research set may comprise utilizing a multi-level decision tree. In one embodiment, a multi-level decision tree may comprise analyzing metrics such as past queries, search result selections, edit distance, or timestamp difference. If a determination, step 404, concludes that the query is part of a research set, a search engine results page (“SERP”) is displayed, step 416. In accordance with an alternative embodiment, the method may comprise generating a new research set if the determination concludes that the received query does not belong to an existing research set, step 404.

If the check at step 404 indicates that the received query is part of an existing research set, the method opens the research set associated with the received query and displays the SERP, step 406. In the embodiment of FIG. 4, a single research set associated with a given query may be selected. In accordance with alternative embodiments, the method may select a plurality of research sets to which a received query belongs. For example, the query “plasma TV” may belong to a research set regarding the purchase of a television as well as a research set related to the construction of and electronics present within a plasma television. Where multiple research sets exist for a single query, the method may automatically select a given set (e.g., choosing the most recent set). Alternatively, the method may provide a list of research sets and may receive an indication from the user regarding the research sets to which a query belongs.

While displaying the SERP, user clicks may be monitored, step 408. In one embodiment, monitoring user clicks may comprise executing client side code that monitors the selections of hyperlinks associated with search results, sending a beacon to a search engine server indicating that a user has selected a given hyperlink. For example, upon selecting a link an AJAX beacon may transmit the indication to a search engine. Alternatively, upon selecting a hyperlink, a client device may be directed towards a redirect server that records the user selection and forwards the user to the requested search result.

Upon receiving an indication of a user click, the method 400 stores the clicks in research data, step 410. In one embodiment, storing click data may comprise recording the URL of the search result; the date and time the result was click; the query associated with the search result; and any other relevant search result data. In accordance with a first embodiment, storing clicks in research data may comprise writing the research data to a local, client-side cache. For example, the method 400 may store click data in a client-side cookie for subsequent retrieval. In an alternative embodiment, the method 400 may store research data in a lightweight data store located on a search engine or other location remote from the client. In one embodiment, lightweight data store may comprise a data structure and related program code operative to intercept incoming research data prior to processing at the search engine.

After processing a user click, a determination is made as to whether a new query is submitted, step 412. If a new search query is not received, the method continues to display and monitor the SERP, steps 406, 408 and 410. If a new search query is received, step 412, a determination is made as to whether the new query is part of the current research set, step 414. In one embodiment, the method may analyze the terms comprising the new query, as well as the date of the new query, with various metrics associated with the current research set. If the method determines that the new query belongs in the current research set, the method displays the SERP for the new query 406; monitors the SERP click activity 408; and stores the click data with the active research set 410.

If it is determined that the new query is not part of the active research set, program flow returns to step 404 and a check is made to determine if a new research set should be opened. In one embodiment, determining if a new research set should be opened may comprise automatically determining if a new research set should be opened. In an alternative embodiment, determining if a new research set should be opened may comprise receiving information from a given user regarding whether a new research set should be opened.

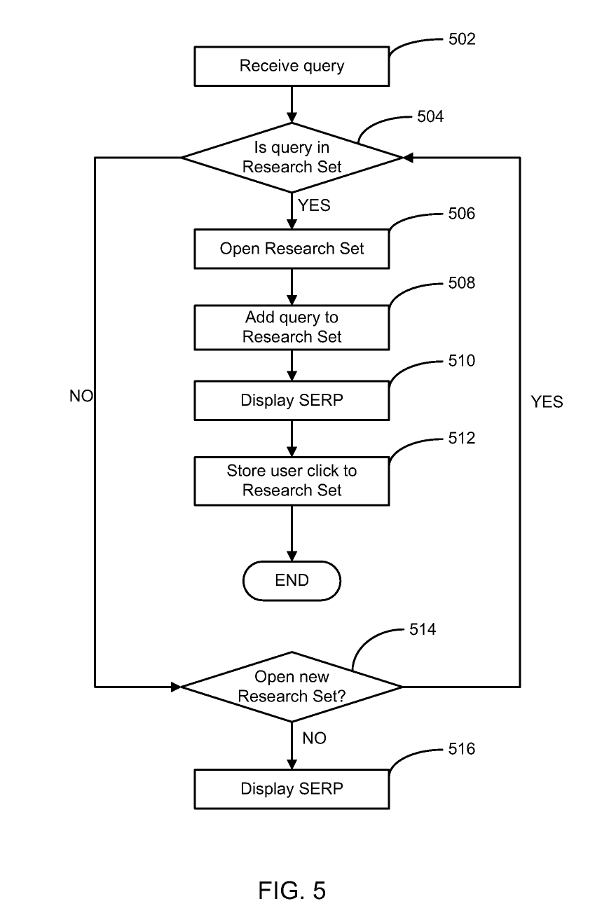

FIG. 5 presents a flow diagram illustrating a method for determining whether a search query belongs to an existing research set, according to one embodiment of the present invention. As the embodiment of FIG. 5 illustrates, the method receives a query, step 502, which according to one embodiment comprises receiving a query comprises receiving a search query entered into a search engine results page.

A determination is made to check if the received query belongs to an existing research set, step 504. In one embodiment, determining if a received query belongs to an existing research set comprises analyzing the terms comprising the query and the date or time the query was submitted. The method of FIG. 5 may analyze one or more past queries or search results within a given research set to determine whether the received query belongs to one or more of the research sets, step 504.

If the check at step 504 indicates that the query is not part of an existing research set, the method determines whether a new research set should be opened, step 514. In one embodiment, determining if a new research set should be opened may comprise automatically determining if a new research set should be opened. In an alternative embodiment, determining if a new research set should be opened may comprise receiving information from a given user regarding whether a new research set should be opened. If check at step 514 indicates that a new research set should not be opened, the method displays the SERP for the received query, step 516. If the method determines a new research set should be opened, step 514, a new research set is created and the received query is added to the new research set, step 508.

If check, step 504, determines the received query belongs to an existing research set, the method opens the research set, step 506. Although illustrated as a single research set, in alternative embodiments, the method 500 may open a plurality of research sets associated with the received query. The query is added to the research set, step 508, which according to one embodiment comprises storing the query to a local or remote storage device. Storing a query may comprise storing the query terms, query time, query identifier or any other query-related metrics known in the art.

After storing the query, the SERP is displayed to the user on the client device, step 510. Displaying a SERP may comprise providing a plurality of markup and executable program files operative to display data and manipulate data on a client device. For example, displaying a SERP may comprise transmitting HTML and JavaScript files to a client device. The SERP may then be monitored for user interactions including, but not limited to, the selection of search results.

In the embodiment of FIG. 5, the method stores user clicks on the opened research set, step 512, which may comprise monitoring the SERP to identify when a user has selected a given search result and store data representing the user click to a storage module. In one embodiment, data representing a user click may comprise the URL of the search result the user selects, the title of the search result, the query associated with the search result, the time the result was click and any other search result metric known in the art.

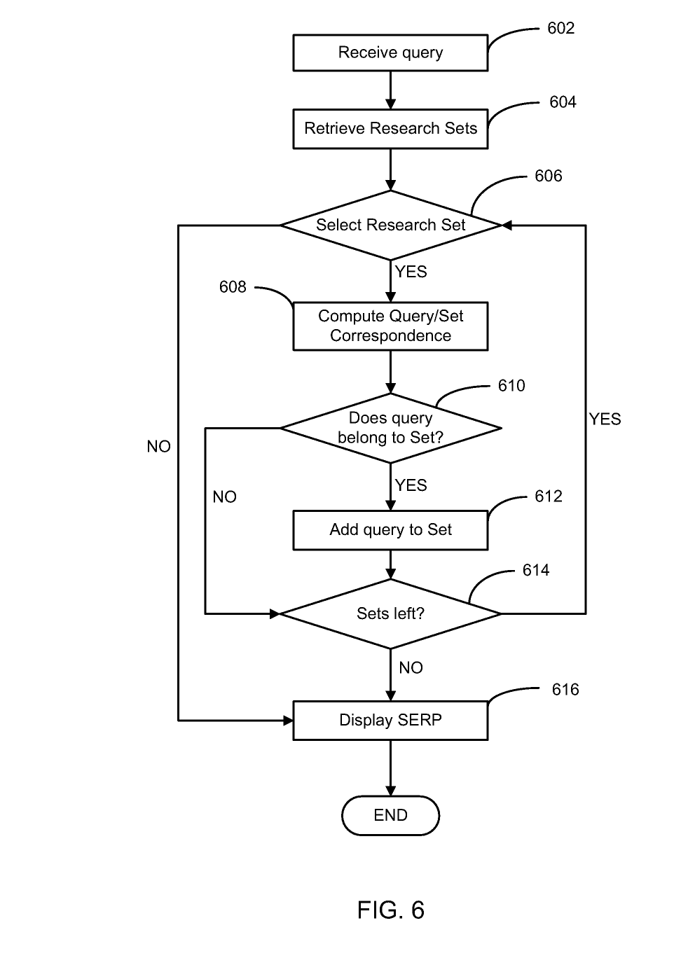

FIG. 6 presents a flow diagram illustrating an alternative method for determining whether a search query belongs to an existing research set according to one embodiment of the present invention. As the embodiment of FIG. 6 illustrates, the method receives a query, step 602, which may comprise receiving a search query provided over a network to a search engine.

In response, the method may retrieve one or more research sets, step 604. In one embodiment, retrieving a plurality of research sets may comprise retrieving a plurality of research data from a client-side or server-side storage module. For example, in a first embodiment, the method 600 may query a client-side lightweight storage module to retrieve recently accessed researched sets. In a second embodiment, the method 600 may query a server-side storage module containing a plurality of research sets associated with a plurality of user. In alternative embodiments contemplate various combinations of querying both a lightweight client-side data store and a long-term server-side data store.

The method then selects a research set, step 606, and computes a query/set correspondence value for the received query, step 608. In one embodiment, computing a query/set correspondence value may comprise calculating a probability that the received query belongs to the selected research set. For example, the method may calculate the term frequency of a research set that indicates a research set contains a plurality of terms occurring at a plurality of locations. In this embodiment, the method may compare the terms of the received query with the weight terms in the research sets.

A check is performed to determine if the received query belongs to the selected research set, step 610. In one embodiment, the method uses the query/set correspondence value to determine if the received query belongs to the selected set. For example, determining that if the query/set correspondence value is above a predetermined threshold, the received query belongs to the research set. If the check determines that the received query belongs to the selected set, step 610, the query is added to the research set, step 612.

In one embodiment, adding a query to the selected research set may comprise writing query-related information to a data store or data structure. Query-related information may comprise the query terms, the query time, a query identifier and a research set identifier. In one embodiment, storing query-related information may comprise storing the information in a relational database. In alternative embodiments, storing query-related information may comprise storing the information to a flat file, such as a cookie. If additional research sets remain for analysis, step 614, program flow returns with the execution of steps 606, 608, 610, and 612 for the remaining research sets. If no sets remain, the method 600 displays the SERP for the received query.

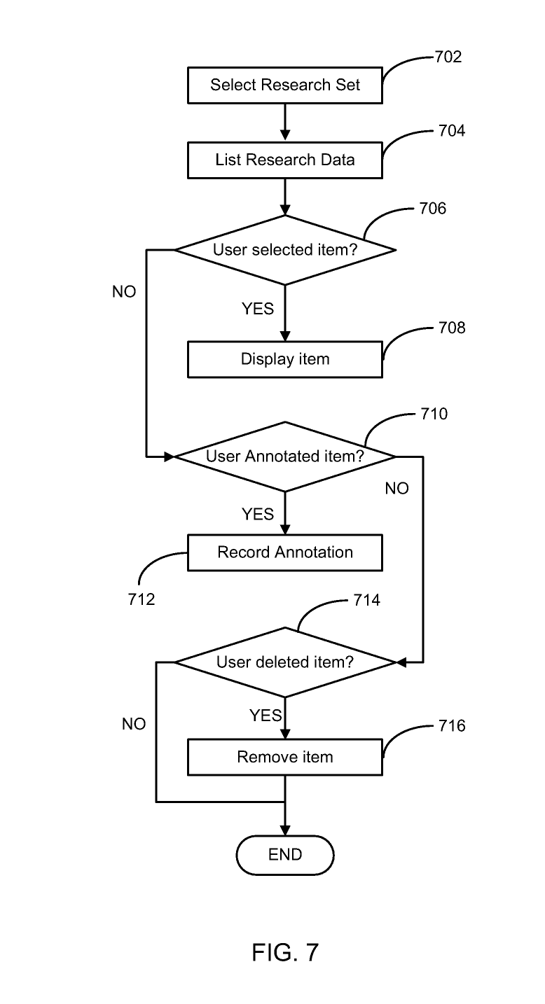

FIG. 7 presents a flow diagram illustrating a method for manipulating a research set graphical user interface according to one embodiment of the present invention. As the embodiment of FIG. 7 illustrates, the method may begin by the selection of a research set, step 702. In one embodiment, selecting a research set for opening or retrieval may comprise automatically selecting a research set. In an alternative embodiment, selecting a new research set may comprise receiving information from a given user regarding whether a new research set should be selected.

Upon selecting a research set, research data in the research set is listed or otherwise presented to the user, step 704. In one embodiment, listing research data may comprise rendering the research data within a SERP using executable code such as JavaScript, VBScript or the like. For example, the method may output an HTML DIV element comprising various graphical elements that illustrate the data stored within a research set such as a listing of queries, a listing of selected search results comprising the search result title or URL and a thumbnail of the search result. The method may also be operative to display a listing of user annotations associated with the research data. In one embodiment, annotations may comprise user notes associated with a search query or with a search result.

A check is made to determine if a user has selected an item present within the research data, step 708. If so, the selected item is displayed, step 710, which may include retrieval of the selected item. In one embodiment, selecting an item in the research data may comprise clicking on a search query or search result presented in a graphical user interface. For example, listing one or more search queries and results as hyperlinks that act as pointers to the appropriate queries and results.

If the selection of an item is not detected, a check is performed to determine if a user wishes to supply an annotation for a given item, step 710. If the check evaluates to true, the annotation is recorded, step 712. In one embodiment, recording an annotation may comprise saving a user annotation to a local or remote data structure and associating the annotation with a search query or search result stored within a research set.

If the recordation of an annotation is not detected, step 710, a check is performed to determine if a user wishes to delete an item, step 714. If so, the identified item is removed, step 716. In one embodiment, local or remote program code executes to monitor a graphical user interface or otherwise detect the selection of an item for removal, e.g., the selection of a deletion control or monitoring the keystrokes of a given user for the depression of a deletion key. Removing an identified item may comprise removing an entry from a database. In alternative embodiments, removing an identified item may comprise removing a file from a storage device.

FIGS. 1 through 7 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for performing research using a search engine, the method comprising:
receiving a search query from a user;
providing a search engine results page in response to the search query;
determining if the user is performing research;
if the user is performing research, generating a research set associated with the research;
storing at least one query associated with the research as part of the research set;
monitoring said search engine results page for user interactions; and
storing at least one user interaction with said search engine results page as part of the research set.
